(19) United States
(12) Patent Application Publication
(10) Pub. No.: US 2008/0189154 A1
(43) Pub. Date: Aug. 7, 2008

(54) Systems and methods for business continuity and business impact analysis

(76) Inventor: Robert Wainwright, Zurich (CH)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/004,021

(22) Filed: Dec. 20, 2007

Related U.S. Application Data
(60) Provisional application No. 60/898,991, filed on Feb. 2, 2007.

(51) Int. Cl. G06Q 10/00

(52) U.S. Cl. 705/7

(57) ABSTRACT

Methods are disclosed for providing business continuity. In one implementation, a business impact analysis method is provided for determining time-critical business units in an organization. The method includes estimating a set of time values for a business unit, the set of time values indicating points of time when a business impact of the business unit will increase, and calculating a resilience impact rating of the business unit based on the estimated time values, wherein the resilience impact rating provides a metric for quantifying a time-criticality of the business unit. The method further includes setting an impact threshold at a specific resilience impact rating value, and identifying the business unit as time-critical business unit if the resilience impact rating is greater than or equal to the impact threshold.

### RELATED APPLICATION(S)

This application claims the benefit of priority from U.S. Provisional Patent Application No. 60/898,991, filed Feb. 2, 2007, entitled “Business Continuity Framework,” the disclosure of which is expressly incorporated herein by reference to its entirety.

### BACKGROUND

1. Technical Field

The present invention generally relates to the fields of risk assessment and business continuity management for an organization. More particularly, the invention relates to systems and methods for analyzing risk associated with disruptions to business continuity and, moreover, to a framework for developing, maintaining, and using response plans to a business disruption.

2. Background Information

Maintaining normal business operations is critical for an organization. Disruptions that cause interruptions to normal business operations can cause severe financial losses. The length of a business disruption often correlates directly to the degree of loss resulting from the business disruption. Accordingly, business continuity (BC) is a high priority for many organizations. Business continuity management is, in part, based on a progression of measures aimed at recovering normal business operations of an organization after a business disruption occurs and minimizing the impact a business disruption can have on the operations of an organization.

To address these issues, organizations develop business continuity plans (BCP) to manage business continuity. These plans may include one or more processes for assessing risks, identifying critical resources, and/or monitoring the status of resources using readiness indicators. BCPs may also include processes for developing adequate recovery plans, producing reports, and/or conducting business continuity tests. Such processes may be implemented in whole, or in part, using computerized or software-based systems and components.

Despite these efforts, business continuity plans and tasks related to business continuity often lack consistency and specificity. For a large enterprise comprising multiple business units, including companies, groups, departments, branches, and/or offices, a business continuity plan of one business unit may be significantly different from that of another business unit. This disparity can cause confusion and may require unnecessary education of employees. Furthermore, with such disparity among various business units in a large organization, a manager of one business unit developing a response plan may not fully account for possible dependencies on other business units within the organization. This can result in inefficient, or even inadequate, response plans.

Furthermore, conventional business continuity plans do not provide a metric or other form of indicator for uniformly measuring the criticality of each business unit in an organization. Such indicators may be critical to determine, with specificity, which business units require response plans and/or to develop response plans that stress the recovery of more critical business units over non-critical business units in an organization.

In view of the foregoing, there is a need for improved systems and methods that minimize the impact resulting from a business disruption. There is also a need for systems and methods for assessing risk associated with business disruption and, more generally, there is a need for a framework for managing business continuity. For large organizations, there is also a need for a common, global framework encompassing all aspects of business continuity related to the organization as a whole.

### SUMMARY

Consistent with embodiments of the invention, systems and methods are provided for analyzing and/or managing risk associated with disruption(s) to business continuity. Embodiments of the invention also include systems and methods for providing a framework to develop, maintain, and use response plans to a business disruption. In certain embodiments, a common framework can be implemented that encompasses all aspects of business continuity related to a large organization as a whole.

In accordance with one embodiment, a method is provided for providing business continuity in an organization. The method comprises identifying risks that can cause a business disruption; developing a response plan for responding to the business disruption based on the identified risks; responding to the business disruption by executing the response plan; and maintaining the response plan during normal business operation, wherein maintaining the response plan comprises performing a business impact analysis using a quantifiable metric to identify time-critical business units in the organization.

Consistent with an aspect of the invention, the quantifiable metric may comprise resilience impact ratings. Further, the step of performing a business impact analysis may comprise: identifying business units in the organization; defining levels of impact; estimating a set of time values for each business unit, the set of time values indicating a duration of time from the start of the business disruption to when the business unit would reach the levels of impact; calculating an initial resilience impact rating for each business unit based on weighted values of the set of time values; determining inter-department dependencies for the business units whose initial resilience impact rating is greater than or equal to a criticality threshold; calculating final resilience impact rating for each business unit based on the inter-department dependencies; identifying business units whose final resilience impact rating is greater than or equal to the criticality threshold as time-critical business units; and developing the response plan for the time-critical business units based on the final resilience impact rating and the inter-department dependencies.

In certain embodiments, the response plan may include a recovery time objective. Furthermore, the method may include generating an impact portfolio for the business units based on the resilience impact ratings and recovery time objectives of the business units.

Consistent with another embodiment of the present invention, a system is provided for providing business continuity in an organization. The system comprises means for identifying risks that can cause a business disruption; means for developing a response plan for responding to the business disruption based on the identified risks; means for responding to the business disruption by executing the response plan; and means for maintaining the response plan during normal business operation, the means for maintaining the response plan comprising means for performing a business impact analysis using a quantifiable metric to identify time-critical business units in the organization.

Consistent with an aspect of the invention, the quantifiable metric may comprise resilience impact ratings. Further, the means for performing a business impact analysis may comprise: means for identifying business units in the organization; means for defining levels of impact; means for estimating a set of time values for each business unit, the set of time values indicating a duration of time from the start of the business disruption to when the business unit would reach the levels of impact; means for calculating an initial resilience impact rating for each business unit based on weighted values of the set of time values; means for determining inter-department dependencies for the business units whose initial resilience impact rating is greater than or equal to a criticality threshold; means for calculating final resilience impact rating for each business unit based on the inter-department dependencies; means for identifying business units whose final resilience impact rating is greater than or equal to the criticality threshold as time-critical business units; and means for developing the response plan for the time-critical business units based on the final resilience impact rating and the inter-department dependencies. Furthermore, the system may include means for generating an impact portfolio for the business units based on the resilience impact ratings and recovery time objectives of the business units.

Consistent with another embodiment of the present invention, a business impact analysis method is provided for determining time-critical business units in an organization. The method comprises estimating a set of time values for a business unit, the set of time values indicating points of time when a business impact of the business unit will increase; calculating a resilience impact rating of the business unit based on the estimated time values, wherein the resilience impact rating provides a metric for quantifying a time-criticality of the business unit; setting an impact threshold at a specific resilience impact rating value; and identifying the business unit as time-critical business unit if the resilience impact rating is greater than or equal to the impact threshold.

In accordance with one aspect of the invention, the step of estimating time values may comprise: defining multiple levels of increasing impact; and determining a duration of time from the start of a business disruption to when the business unit will reach each of the multiple levels of increasing impact. Further, the step of calculating the resilience impact rating may comprise summing weighed values of the set of time values. In one embodiment, the step of calculating the resilience impact rating is based on the following formula:

$$R I R = \frac{{W}_{1}}{{T}_{1}} + … + \frac{{W}_{N}}{{T}_{N}} ,$$

wherein RIR is the resilience impact rating, W₁ . . . W_{N} are weights, and T₁ . . . T_{N} are the set of time values for N levels of increasing impact.

Consistent with another embodiment of the present invention, a business impact analysis system is provided for determining time-critical business units in an organization. The system comprises means for estimating a set of time values for a business unit, the set of time values indicating points of time when a business impact of the business unit will increase; means for calculating a resilience impact rating of the business unit based on the estimated time values, wherein the resilience impact rating provides a metric for quantifying a time-criticality of the business unit; means for setting an impact threshold at a specific resilience impact rating value; and means for identifying the business unit as time-critical business unit if the resilience impact rating is greater than or equal to the impact threshold.

In accordance with one aspect of the invention, the means for estimating time values may comprise: means for defining multiple levels of increasing impact; and means for determining a duration of time from the start of a business disruption to when the business unit will reach each of the multiple levels of increasing impact. Further, the means for calculating the resilience impact rating may comprise means for summing weighed values of the set of time values. In one embodiment, the means for calculating the resilience impact rating calculates a resilience impact rating based on the following formula:

$$R I R = \frac{{W}_{1}}{{T}_{1}} + … + \frac{{W}_{N}}{{T}_{N}} ,$$

wherein RIR is the resilience impact rating, W₁ . . . W_{N} are weights, and T₁ . . . T_{N} are the set of time values for N levels of increasing impact.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this specification, illustrate various embodiments of the invention and together with the detailed description, serve to explain the principles of the invention. In the drawings:

FIGS. 1A and 1B illustrate flow charts of exemplary business continuity methods, consistent with an embodiment of the invention;

FIG. 2 illustrates an exemplary hierarchical structure of response plans, consistent with an embodiment of the invention;

FIG. 3 illustrates of a flow chart of an exemplary method for performing a business impact analysis including resilience impact rating calculations, consistent with an embodiment of the invention;

FIGS. 4A to 4E are diagrams associated with an exemplary calculation of resilience impact ratings, consistent with embodiments of the invention;

FIG. 5 is an exemplary impact portfolio, consistent with an embodiment of the invention;

FIG. 6 illustrates an exemplary system environment for providing business continuity, consistent with an embodiment of the invention; and

FIG. 7 illustrates an exemplary computer system, consistent with an embodiment of the invention.

### DETAILED DESCRIPTION

Reference will now be made in detail to the present invention, examples of which are illustrated in the accompanying drawings. Wherever possible, the same reference numbers will be used throughout the drawings to refer to the same or like parts.

Systems and methods are disclosed herein for providing business continuity. Embodiments of the invention may be advantageously implemented by organizations of any size and structure for performing risk assessment and/or business continuity management. Examples of such organizations include, for instance, corporations, partnerships, government agencies, etc. An organization may consistent of one or more business units. A business unit of an organization is a logical, discrete collection of personnel or staff which performs one or more functions. Examples of a business unit include, for instance, a department of an organization.

Consistent with an aspect of the present invention, a business continuity framework (BCF) may be implemented for an organization. A BCF is an enterprise-wide discipline that may be applied for the purpose of managing risks to an organization. An organization assesses risks and determines the possible impact those risks will have on the organization. Risks are anything that can cause, prolong, or hinder effectively responding to a business disruption. A business disruption, depending on its level of severity and/or duration, can force an organization out of normal business operations or activities. Therefore, it is a goal of most organizations to reduce the impact that may be caused by various risks.

In accordance with another aspect of the invention, a business impact analysis (BIA) may be performed to identify time-critical business units in an organization. In one embodiment, the BIA uses a resilience impact rating (RIR), which provides a globally-relative number or other metric indicating time-criticality of a business unit or a resource. A criticality of a business unit may indicate, for example, the level of impact a business disruption in a business unit will have on the organization. The level of impact is often dependent on the duration of the business disruption. Examples of levels of impact are: non-significant, minor, moderate, significant, and major. These levels can be standardized in the organization by setting in policy the definitions of each levels of impact.

Consistent with additional aspects of the present invention, response plans may be developed to recover an organization back to normal business operations in case of a business disruption. In one embodiment, response plans are organized into a hierarchical structure where the execution of one plan can cause the execution of another plan, usually higher in the hierarchy, through escalation. Details of escalation are defined by escalation points defined for each response plan. Further, each plan in the hierarchy may have a specific role in responding to a business disruption.

Factors that affect business continuity can frequently change. Moreover, the size and structure of an organization may change, as well as risks that can cause a business disruption. Accordingly, consistent with an aspect of the invention, the business continuity framework may be updated to account for such changes. Maintenance of the business continuity framework may comprise updating and providing new response plans to account for the latest state of an organization and factors affecting the business continuity of the organization.

Systems and methods consistent with the present invention may be implemented in whole, or in part, using computerized systems and/or software-based components. For instance, as further disclosed herein, an organization can utilize a business continuity application (BCA) to support maintenance efforts and/or other activities associated with a business continuity framework (BCF).

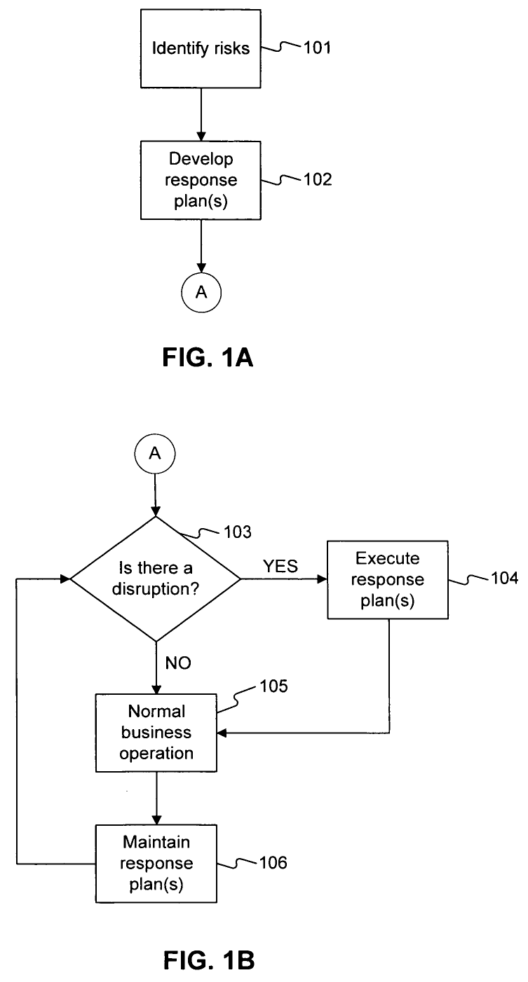

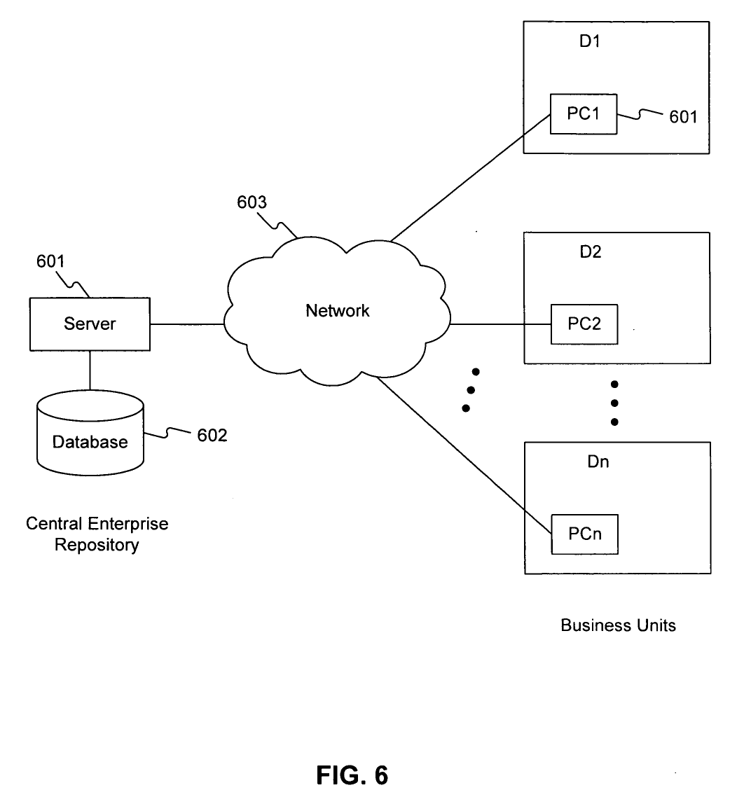

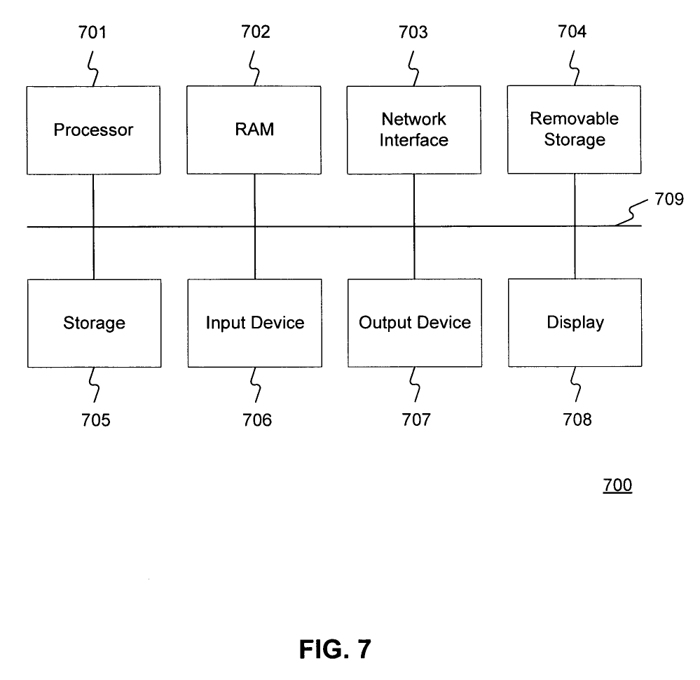

Consistent with an embodiment of the present invention, exemplary methods for providing business continuity will now be described with reference to FIGS. 1A and 1B. The exemplary methods of FIGS. 1A and 1B may be implemented by an organization using a computerized system environment and/or components, such as that described below with reference to FIGS. 6 and 7.

FIG. 1A is a flow chart of an exemplary method for identifying risks and developing response plans. Such a method may be implemented as part of a BCF for an organization. As shown in FIG. 1A, risks that can cause a business disruption to the organization are first identified in step 101. This step may be performed by a plan owner, a department owner, a manager, or any authorized employee of an organization. If the organization is large and/or includes multiple business units, the task of identifying risks may be distributed to a team of plan owner(s), business unit manager(s) and/or authorized employee(s) to coordinate the identification of risks. From a business continuity perspective, the BCF must cover both risks associated with a business disruption occurring and risks associated with ineffectively responding to a business disruption. For most organizations, risks can be generally grouped into four categories: operational, environmental, external, and response.

Operational risks include events or failures that render an organization unable to continue operating in certain aspects. For example, operational risks may be identified in relation to a server or other computer hardware failure, a bomb threat, or a hazardous chemical leak.

Environmental risks include, for example, a loss of power or water to a building. Environmental risk also includes concentration risk of two or more buildings sharing the same resources, such as a power or water supply, as well as accommodating high impact staff or systems such that a large scale event will have simultaneous impact on multiple buildings, i.e., affect multiple business units and/or multiple resources.

External risks include requirements from clients, regulators, third parties, board of directors, and/or audit requirements relating to business continuity. For example, external risks for an organization may be identified with respect to client expectations that may increase and result in a need to decrease the length of a business disruption. External risks may also concern a new regulatory guideline that may be released that changes the scope of certain response(s).

Response risks include risks that can prolong a business disruption by hindering an effective response to the business disruption. Examples of response risks include, for instance, communication breakdown; unavailability or inappropriate solutions; lack of plan ownership and awareness; and/or inaccurate, inconsistent, or inaccessible plans.

An organization can maintain an inventory or database of risks and identify those specific risks with business continuity implications. Such an inventory or database may be maintained in a computerized system (see, e.g., FIGS. 6 and 7) and reflect, for example, organizational studies or assessments of risks that may impact the organization and its operations. Also, such data related to business continuity may be printed out in paper-copy form.

In one embodiment, risks, including those indicated above, may be identified based on historical records of risks and/or future assessed risks for an organization or relevant industry. Response risk may also be based on past testing, drills, or simulations run on the response plans of the organization or related organizations. As will be appreciated by those skilled in the art, the exact risks at issue will depend on a number of factors, including the nature of the organization and the business environment in which it operates.

Referring again to FIG. 1A, in step 102, one or more response plans for responding to business disruptions caused by the various types of identified risks are developed. Response plans may be used to guide activities of specific members of the organization with the goal of containing the business impact and returning the organization back to normal business operations. A response plan can include any number of effective solutions and communication protocols. Thus, as part of the response plan, effective solutions should be identified and defined to provide appropriate processes for addressing the business disruption. These solutions may be developed based on the identified risks and available resources to be used for containing the impact resulting from the identified risks. Effective communication protocols should also be defined to provide timely and accurate correspondence among appropriate members of the organization involved in the execution and reporting of the response plan. Preferably, a response plan developed as part of step 102 links the solutions and communication protocols to facilitate effective decision making during a business disruption. In one embodiment, a response plan may be distributed across the appropriate breadth and depth of an organization. For example, a response plan may include tasks performed by and communications among members of more than one business unit.

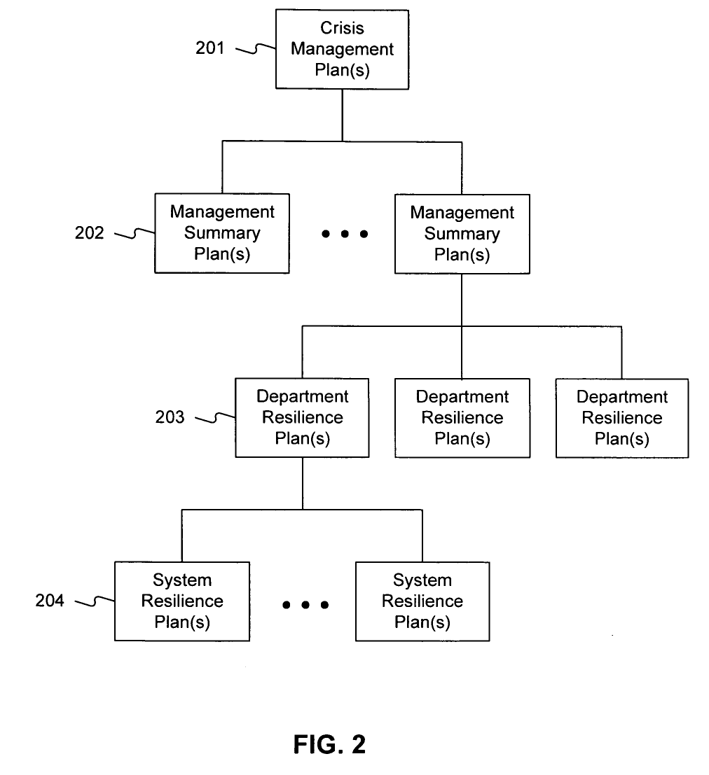

Consistent with an aspect of the invention, a response plan may include an escalation point for executing another plan that is either at the same or a higher level in a response plan hierarchy (see, e.g., FIG. 2). An escalation point can be a step in a plan, an event, or any trigger which executes another plan. In one embodiment, escalation points typically trigger plans that are higher in the hierarchical plan structure.

In accordance with certain embodiments of the invention, a response plan is assigned a plan owner who is a member of the organization. A plan owner is responsible for knowing how to react in case of a business disruption. The plan owner accepts the respective roles and related control objectives assigned to him. The plan owner may also be responsible for continued evaluation of the response plan for its effectiveness.

Consistent with additional embodiments of the invention, a response plan may include a recovery time objective (RTO). An RTO expresses the approximate time between the start of a business disruption to when the business impact should be contained. This target may be defined by a plan owner. The development of a response plan can be based on the target RTO. Also, a response plan may include an escalation point based on the RTO. For example, a response plan for a department may include an escalation point to execute another response plan if the department has not been restored to normal business operations within specific number of hours set by the RTO.

Consistent with an embodiment of the present invention, multiple response plans may be developed that are hierarchically structured. For example, in FIG. 2, a hierarchy of response plans is depicted, consistent with an embodiment of the invention. According to this example, the hierarchy is made up of four plan types: crisis management plans (CMP) 201, management summary plans (MSP) 202, department resilience plans (DRP) 203, and system resilience plans (SRP) 204. Each plan type has a specific objective or role in responding to a business disruption.

The role of the crisis management plan (CMP) 201 is to provide sufficient information to enable an effective damage assessment to be conducted and suitable communication protocol(s) to facilitate efficient command and control. An organization may develop a plurality of CMPs 201. A CMP 201 can escalate to another CMP 201. A CMP 201 can also receive an escalation from one or more MSPs 202.

The role of the management summary plan (MSP) 202 is to provide sufficient information to enable an effective damage assessment to be conducted and suitable communication protocol(s) to facilitate efficient command and control. A MSP 202 can escalate to a CMP 201. A MSP 202 can also receive an escalation from one or more DRPs 203. The MSP owner is a member of the CMP 201 that the MSP 202 escalates to.

The role of the department resilience plan (DRP) 203 is to provide sufficient information to enable an effective damage assessment, appropriate communication requirements to be identified, solution options to be chosen, solution status to be reported, and/or recovery activities to be prioritized based on the time of day and day of year the business disruption occurs. A DRP 203 can escalate to a MSP 202. A DRP 203 also assumes ownership for one or more SRPs 204.

The role of the system resilience plan (SRP) 204 is to consolidate the relevant DRP 203 requirements and recover a particular system (application or infrastructure). An SRP 204 is owned by a DRP 203. Typically, for example, an IT department would own an SRP 204 related to IT systems.

After having identified the risks (step 101) and developed response plans (step 102), an organization can be prepared for an occurrence of a business disruption.

Referring to FIG. 1B, a flow chart of an exemplary method is provided for responding to business disruption and maintaining response plans. As shown in FIG. 1B, when a business disruption occurs (step 103; Yes), one or more appropriate response plans are executed (step 104) in response to the business disruption that has occurred. The execution of the appropriate response plan(s) (step 104) is made to return the organization back to normal business operation (step 105). If there is no business disruption (step 103; No), normal business operation (step 105) is carried out directly. In parallel with normal business operation or at scheduled intervals, an organization may also maintain its response plans (step 106).

Consistent with embodiments of the invention, response plan(s) may be maintained (step 106) to ensure the effectiveness of the response plans. Response plan maintenance is a continuous process of on-going efforts to ensure that the organization is ready to respond to business disruptions caused by the risks. Maintaining response plans may include further identifying new risks and developing new response plans or reassessing previously identified risk and updating existing response plans in order to ensure that the current BCF is consistent with the present state of the organization, as well as any factors affecting the BC of the organization. Accordingly, maintaining response plans may include steps similar to that shown in FIG. 1A, including the steps of identifying risks (step 101) and developing response plans (step 102). In any event, the process of maintaining response plans should be performed regularly by an organization to ensure that the response plans are not out-of-date, possibly rendering them ineffective.

Development and maintenance of a BCF can be costly. Therefore, in accordance with one embodiment, an organization can prioritize risks and business units according to their importance based on business impact and available resources for BC.

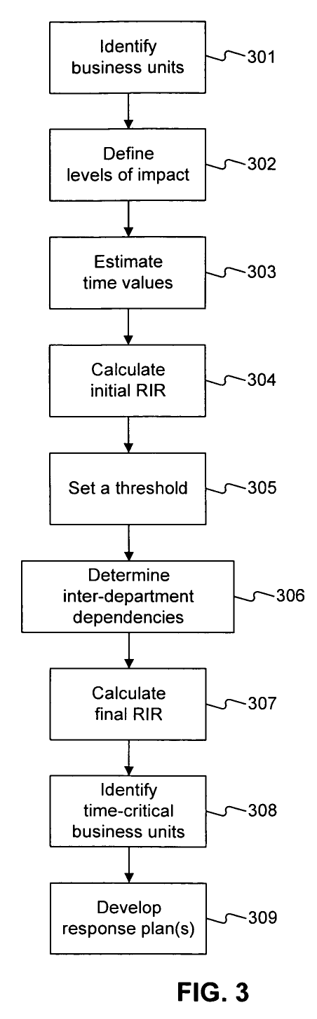

Consistent with an embodiment of the invention, a business impact analysis (BIA) may be performed to identify time-critical business units in an organization for purposes of developing a response plan (see step 102, FIG. 1A) or updating a response plan as part of maintaining the response plan (see step 106, FIG. 1B). As described below in connection with the exemplary method of FIG. 3, a BIA may incorporate a resilience impact rating (RIR). Consistent with an aspect of the invention, a RIR may provide a globally relative number or metric indicating the time criticality of a business unit. The scale of this metric is uniform across the organization among all business units.

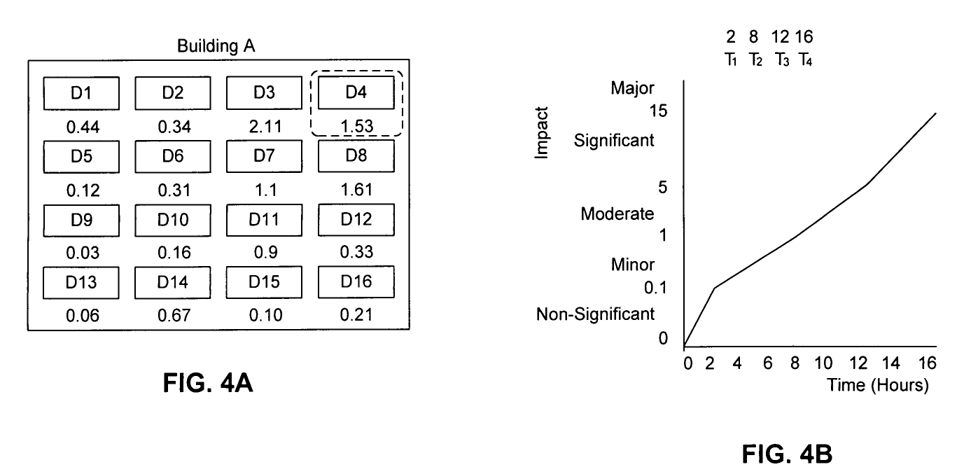

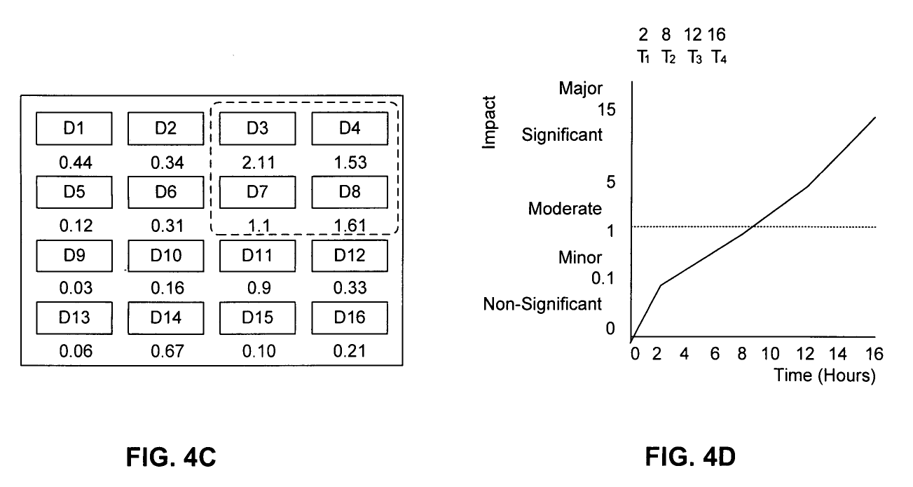

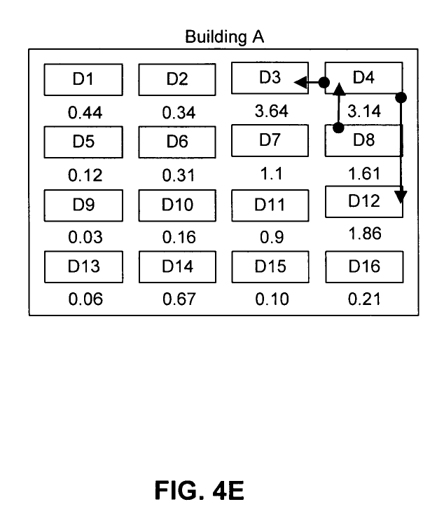

FIG. 3 illustrates of a flow chart of an exemplary method for performing a business impact analysis (BIA), consistent with an embodiment of the invention. Because it may be cost-ineffective to develop and allocate resources for extensive response plans for all business units in an organization, response plans may be developed primarily or only for business units identified as time-critical. In general, these time-critical business units have a higher need and urgency to be restored to normal business operation after a business disruption occurs. This urgency can be determined, for example, based on the impact a business disruption of a business unit will have on the organization. BIA is conducted for each business unit in an organization based on the identified risks. An exemplary BIA, including exemplary RIR calculations, is described below with reference to FIGS. 3 and 4A-4E.

As shown in FIG. 3, business units in the organization are first identified and/or defined (step 301). Business units of an organization are logical, discrete units of staff. For example, a department in the organization may be considered a business unit. Each department will be examined for its importance and criticality. A member of the department may be selected as the department owner who would accordingly be the plan owner of the corresponding DRP 202 for that department. The division of an organization into multiple business units is based, at least in part, on consideration of the role of the business unit in the organization, risks associated with the business unit, and resources required for execution of response plans associated with the business unit. In an example shown in FIG. 4A, an organization in Building A comprises sixteen departments: D1 to D16.

Next, the levels of impact are defined (step 302). Each level may indicate the level of impact a business disruption of the business unit will have on the organization. An organization may choose any appropriate number and labels for the levels of impact. In an embodiment consistent with the present invention, as shown in the example of FIG. 4B, five distinct levels of impact are defined as “Non-Significant”, “Minor”, “Moderate”, “Significant,” and “Major” in order of increasing levels of impact. Furthermore, numerical values are assigned to the lower and upper range of the level of impact to provide a metric scale to the levels of impact. For example, the Non-Significant level of impact may range from 0 to 0.1, the Minor level of impact may range from 0.1 to 1, the Moderate level of impact may range from 1 to 5, the Significant level of impact may range from 5 to 15, and the Major level of impact may be greater than 15. This scale would be used consistently throughout the organization by all the business units.

Levels of impact may be defined based on the amount of financial loss the organization will suffer due to the business disruption. For example, a loss of $0-1 million may be considered Non-Significant; a loss of $1-10 million may be considered Minor; a loss of $10-50 million may be considered Moderate; a loss of $50-150 million may be considered Significant; and a loss of more than $150 million may be considered Major. The exact dollar amounts will depend on many variables associated with specific organizations and the amounts can be reevaluated and adjusted as those variables change over time. Alternatively, the levels of impact may be defined by specific events or descriptive damages. For example, unpleasant coverage about the organization in the press may be classified as Significant and anything causing a shutdown of an entire manufacturing plant may be classified as Major.

Often, a business disruption has higher impact on the organization as the length of the time of the business disruption increases. As such, the longer it takes to resolve a business disruption and return the business unit to normal business operations, higher levels of impact the business unit will reach. Accordingly, in the next step (step 303), time values are estimated for each business unit, wherein the time values represent the length of time after the start of a business disruption at which point the business unit will increase in business criticality from one level to the next. This task may be performed by the department owner or any appropriate member of the organization. The department owner estimating these time values may also be the DRP plan owner.

In the example of FIG. 4B, an employee of the organization estimates the time (for example, in hours) at which point the business impact will move from one level of impact to the next. T₁, T₂, T₃, and T₄ represent the number of hours from the beginning of a business disruption when the business impact will move from being Non-Significant to Minor, Minor to Moderate, Moderate to Significant, and Significant to Major, respectively. For example, it may determined that the level of impact resulting from a business disruption in department D4 takes 2 hours to move from Non-Significant to Minor, 8 hours to move from Minor to Moderate, 12 hours to move from Moderate to Significant, and 16 hours to move from Significant to Major. It is possible for a disruption in certain departments to never reach certain level of impact. FIG. 4B depicts these estimated time values plotted on a graph showing a progression of increasing level of impact as the duration of a business disruption increases.

Then, as shown in FIG. 3, initial RIR values are calculated for each business unit based on weighted sums of the estimated time values (step 304). For example, RIR can be calculated using the following formula:

$$R I R = \frac{0.1}{{T}_{1}} + \frac{1}{{T}_{2}} + \frac{5}{{T}_{3}} + \frac{15}{{T}_{4}} ,$$

wherein 0.1, 1, 5, and 15 are weights. The weights are provided by the border values of the defined levels of impact. FIG. 4A shows the RIR values calculated for the sixteen departments, D1 to D16. In this example, the RIR for department D4 is 1.53.

Next, a threshold value is set (step 305) in order to distinguish the time-critical departments from non-time-critical departments. The threshold is used to determine a boundary within which to focus attention in developing BCPs. Setting a threshold provides a filter to narrow the scope of BCF. The value of the threshold can depend on many factors including the organizations resources for BCF, the determined initial RIR values, the RTOs set for the business units. The threshold may be reviewed and adjusted regularly.

After the threshold value has been set, the RIR values for the individual business units are compared against the threshold to determine which business units are time-critical business units. Business units whose RIR values are higher than the threshold are considered time-critical business units.

In the example shown in FIG. 4D, the threshold value is set at 1.0 and depicted by a dotted line. Accordingly, departments D3, D4, D7, and D8, marked by a dotted line surrounding those departments, in FIG. 4C, are determined as the time-critical departments because these departments have RIR values greater than or equal to the threshold value of 1.0. Conversely, departments D1, D2, D5, D6 and D9-D16 are determined as non-time-critical business units because these departments have RIR values less than the threshold value of 1.0.

For business units whose initial RIR values are greater than or equal to the threshold value, inter-departmental dependencies are determined (step 306). Inter-department dependencies are requirements of one business unit which must be satisfied or fulfilled in order for another business unit to execute or continue executing its response plan. For example, one department can have a response plan to relocate its employees to another department to resume operations during a business disruption. This department's response plan requires that the other department's location is available and can accommodate the relocation of employees. As another example, a response plan for one department may include using the organization's emailing system. Such a response plan could not be executed if the IT department is also disrupted by the same disruption. Furthermore, RTOs for business units may be changed in view of the identified inter-departmental dependencies.

FIG. 4E shows examples of inter-department dependencies indicated by arrows from one department to another. For example, an arrow from department D4 to department D3 means that the execution of a response plan for department D3 is somehow dependent on the status of department D4. Furthermore, departments whose RIR values are greater than or equal to the threshold value may depend on a department whose RIR value is less than the threshold, and visa versa. For example, as shown in FIG. 4E, department D16 whose RIR value is less than the threshold value is dependent on department D4 whose RIR value is greater than the threshold value.

In view of the dependencies, final RIR values are calculated (step 307) based on the initial RIR values and the inter-department dependencies. In an embodiment consistent with the present invention, one way to calculate the final RIR values is to increase initial RIR value of the dependent department by the initial RIR value of the department it is dependent upon. Using the example in FIG. 4E, RIR value for department D4 has been updated from the initial RIR value of 1.53 to the final RIR value of 3.14 by 1.61, which is the initial RIR value of department D8 because of an inter-department dependency of department D4 on department D8. Final RIR values for all departments related to the determined inter-department dependencies are determined.

Thereafter, business units whose final RIR values are greater than or equal to the threshold value are identified as time-critical business units (step 308). By comparing the final RIR values, which may be different from the initial RIR values, with the threshold value, it is possible to have a different set of time-critical departments than previously determined using the initial RIR values.

In another embodiment consistent with the present invention, a second threshold value, possibly different from the first threshold value, may be set after calculating the final RIR values for determining the final set of time-critical business units. A different threshold value may be appropriate depending on the number of departments whose final RIR values are higher than the initial threshold value and the resources available for BC.

Now, following steps 310-308, response plan(s) can be developed for the determined time-critical business units (step 309). In developing a response plan, all relevant inter-department dependencies should be considered.

Consistent with embodiments of the invention, a plan owner may be the one responsible for conducting the business impact analysis (BIA) in order to assess whether a response plan needs to be established for a business unit. If the business unit is assessed as being non-time-critical, no further action is required from the plan owner. If, however, the business unit is considered time-critical, the plan owner needs to develop a response plan, which outlines the operational targets the plan owner and other members of the organization will achieve in case of a business disruption. The key tasks to be performed by the plan owner include, for example, identification of dependencies to other business units; identification of staff and alternative personnel to execute the response plan; and identification of escalation points.

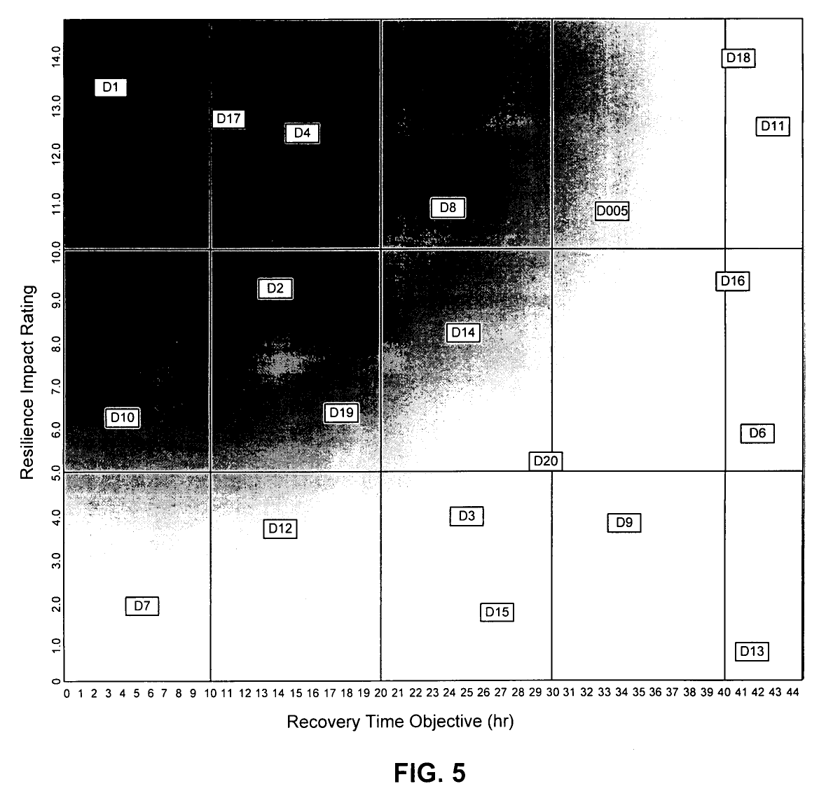

Referring to FIG. 5, an exemplary impact portfolio is illustrated, consistent with an embodiment of the present invention. Such an impact portfolio may be produced to display the relative positions of business units in an organization with respect to the business units' RIRs and RTOs. For example, department D1 in FIG. 5 has a relatively high RIR and also a relatively short RTO. Accordingly, development of a response plan for department D1 should reflect the relative time-criticality of department D1 compared with other departments. Conversely, department D13 has a relatively low RIR and also a relatively long RTO. This indicates that developing a response plan for D13 may not be as important compared with other departments. An impact portfolio such as that shown in FIG. 5 allows members of an organization, especially those developing response plans, to visualize the globally-relative positions of the business units in the organization based on RIRs and RTOs in order to determine which business units are more time-critical than others. An impact portfolio can further assist various steps related to BC, such as setting a threshold value (step 305), setting an RTO for a business unit, etc.

Furthermore, consistent with an aspect of the invention, an RTO can also represent the elapsed time between the start of a business disruption to when the business impact was actually contained from past business disruptions or past simulations. From such statistical data, an impact portfolio generated after a business disruption or simulation can depict a plot of business units against their RIR and the time it took to restore each business unit to their normal business operations. A plan owner can use such an impact portfolio to analyze or reassess risks, adjust threshold values, update response plans, or reassess inter-department dependencies as part of maintaining the response plans.

Consistent with an embodiment of the present invention, a business continuity application (BCA) may be provided to support the BCF, thereby enabling the development, implementation, maintenance, management, and testing of accurate and up-to-date response plans. By way of example, the BCA application may be implemented as a client-server application operating in a networked environment, such as that depicted in FIGS. 6 and 7. While such examples are presented below, a BCA application may be implemented through any suitable combination of hardware, software, and/or firmware.

As shown in the exemplary embodiment of FIG. 6, a BCA server 601 includes a database 602 which stores information related to the business continuity framework of an organization including, for example, response plans, plan owners, and RIR values of business units. BCA server 601 and database 602 may be located in a central enterprise repository and connected to a network 603, thus allowing access by clients such as authorized employee PCs throughout the organization. For example, the organization may comprise n number of business units, departments D1 to Dn. In those departments are one or more computers, such as PC1 to PCn. A personal computer PC1 604 in department D1 runs the BCA client application to allow a user, such as a plan owner, to support the maintenance aspect of the business continuity framework including, for example, modifying response plans, printing out hard paper copies of response plans, etc. Hard copies of the response plans may be used as a back-up in business disruptions where, for example, client computers 604 are not available or not able to access to the necessary response plan(s) due to a failure in database 602, BCA server 601, or network 603.

Consistent with an embodiment of the present invention, BCA server 601 and PC1 604 may comprise apparatus such as a computer 700, shown in the example of FIG. 7. Computer 700 includes a processor 701 for executing instructions to perform the methods related to BCF. Processor 701 is connected to a data bus 709 which connects various components of computer 700. Computer 700 includes a storage 705 for storing data related to BCF, such as response plans, RIR values of business units, etc. RAM 702 memory is used by processor 701 as a placeholder for active data during the execution of instructions. Computer 700 also comprises one or more input devices 706, for example, a keyboard and a mouse. A user, such as a plan owner, can utilize input device 706 to, for example, input response plans, identify and define business units, etc. A network interface 703 allows computer 700 to be connected to network 603. Computer 700 may comprises a removable storage 704 such as a floppy drive, CDROM, DVD-ROM, and USB flash drive. Computer 700 comprises a display 708, such as a monitor, for displaying to the user various data related to the BCF. The user can interact with the BCA through display 708 and using input device 706. Computer 700 can comprise an output device 707 such as a printer. The user can print out, using the printer, data related to the BCF, such as response plans and impact portfolios. A paper printout of a response plan can serve as a backup copy in case computer 700 is not available during a business disruption.

The present techniques and embodiments described herein, including the exemplary systems and methods presented above, can be implemented in digital electronic circuitry, or in computer hardware, firmware, software, or in any suitable combinations thereof. In addition, apparatus consistent with the present invention can be implemented in a computer program product tangibly embodied in a machine-readable storage device for execution by a programmable processor.

Method steps according to embodiments of the invention can be performed by a programmable processor executing a program of instructions to perform functions or steps of the methods by operating on the basis of input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories, in particular from read-only memories and/or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in ASICs (application-specific integrated circuits).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for providing business continuity in an organization, the method comprising:
identifying risks that can cause a business disruption;
developing a response plan for responding to the business disruption based on the identified risks;
responding to the business disruption by executing the response plan; and
maintaining the response plan during normal business operation, wherein maintaining the response plan comprises performing a business impact analysis using a quantifiable metric to identify time-critical business units in the organization.

2. The method of claim 1, wherein the quantifiable metric comprises resilience impact ratings, and further wherein performing a business impact analysis comprises:
identifying business units in the organization;
defining levels of impact;
estimating a set of time values for each business unit, the set of time values indicating a duration of time from the start of the business disruption to when the business unit would reach at least one of the levels of impact; and
calculating an initial resilience impact rating for each business unit based on weighted values of the set of time values.

3. The method of claim 2, wherein performing a business impact analysis further comprises:
determining inter-department dependencies for the business units whose initial resilience impact rating is greater than or equal to a criticality threshold;
calculating a final resilience impact rating for each business unit based on the inter-department dependencies;
identifying each business unit whose final resilience impact rating is greater than or equal to the criticality threshold as a time-critical business unit; and
developing the response plan for all time-critical business units based on the final resilience impact rating and the inter-department dependencies.

4. The method of claim 1, wherein the response plan comprises at least one of a crisis management plan, a management summary plan, a department resilience plan, and a system resilience plan which are hierarchically ordered.

5. The method of claim 4, wherein at least one of the crisis management plan, the management summary plan, the department resilience plan, and the system resilience plan comprises an escalation point for executing a hierarchically higher plan.

6. The method of claim 1, further comprising identifying risks that can hinder efficiently responding to the business disruption.

7. The method of claim 1, wherein the response plan includes a recovery time objective.

8. The method of claim 1, further comprising generating an impact portfolio for mapping the business units based on the resilience impact rating and the recovery time objective.

9. A system for providing business continuity in an organization, the system comprising:
means for identifying risks that can cause a business disruption;
means for developing a response plan for responding to the business disruption based on the identified risks;
means for responding to the business disruption by executing the response plan; and
means for maintaining the response plan during normal business operation, the means for maintaining the response plan comprising means for performing a business impact analysis using a quantifiable metric to identify time-critical business units in the organization.

10. The system of claim 9, wherein the quantifiable metric comprises resilience impact ratings, and further wherein the means for performing a business impact analysis comprises:
means for identifying business units in the organization;
means for defining levels of impact;
means for estimating a set of time values for each business unit, the set of time values indicating a duration of time from the start of the business disruption to when the business unit would reach at least one of the levels of impact; and
means for calculating an initial resilience impact rating for each business unit based on weighted values of the set of time values.

11. The system of claim 10, wherein the means for performing a business impact analysis further comprises:
means for determining inter-department dependencies for the business units whose initial resilience impact rating is greater than or equal to a criticality threshold;
means for calculating a final resilience impact rating for each business unit based on the inter-department dependencies;
means for identifying each business unit whose final resilience impact rating is greater than or equal to the criticality threshold as a time-critical business unit; and
means for developing the response plan for all time-critical business units based on the final resilience impact rating and the inter-department dependencies.

12. The system of claim 9, further comprising means for identifying risks that can hinder efficiently responding to the business disruption.

13. The system of claim 9, further comprising means for generating an impact portfolio for mapping the business units based on the resilience impact rating and the recovery time objective.

14. A business impact analysis method for determining time-critical business units in an organization, the method comprising:
estimating a set of time values for a business unit, the set of time values indicating points of time when a business impact of the business unit will increase;
calculating a resilience impact rating of the business unit based on the estimated time values, wherein the resilience impact rating provides a metric for quantifying a time-criticality of the business unit;
setting an impact threshold at a specific resilience impact rating value; and
identifying the business unit as time-critical business unit if the resilience impact rating is greater than or equal to the impact threshold.

15. The business impact analysis method of claim 14, wherein estimating a set of time values comprises:
defining multiple levels of increasing impact; and
determining a duration of time from the start of a business disruption to when the business unit will reach each of the multiple levels of increasing impact.

16. The business impact analysis method of claim 14, wherein calculating a resilience impact rating further comprises summing weighed values of the set of time values.

17. The business impact analysis method of claim 16, wherein calculating a resilience impact rating is based on the formula:
$$R I R = \frac{{W}_{1}}{{T}_{1}} + … + \frac{{W}_{N}}{{T}_{N}}$$
wherein RIR is the resilience impact rating, W₁ . . . W_{N} are weights, and T₁ . . . T_{N} are the set of time values for N levels of increasing impact.

18. The business impact analysis method of claim 14, further comprising developing a response plan based on the resilience impact rating of the time-critical business unit.

19. The business impact analysis method of claim 14, further comprising developing a response plan based on inter-department dependencies.

20. The business impact analysis method of claim 14, further comprising maintaining a response plan for the time-critical business unit for responding to the business disruption.

21. A business impact analysis system for determining time-critical business units in an organization, the system comprising:
means for estimating a set of time values for a business unit, the set of time values indicating points of time when a business impact of the business unit will increase;
means for calculating a resilience impact rating of the business unit based on the estimated time values, wherein the resilience impact rating provides a metric for quantifying a time-criticality of the business unit;
means for setting an impact threshold at a specific resilience impact rating value; and
means for identifying the business unit as time-critical business unit if the resilience impact rating is greater than or equal to the impact threshold.

22. The business impact analysis system of claim 21, wherein the means for estimating a set of time values comprises:
means for defining multiple levels of increasing impact; and
means for determining a duration of time from the start of a business disruption to when the business unit will reach each of the multiple levels of increasing impact.

23. The business impact analysis system of claim 21, wherein the means for calculating a resilience impact rating further comprises means for summing weighed values of the set of time values.

24. The business impact analysis system of claim 23, wherein the means for calculating a resilience impact rating calculates a resilience impact rating based on the formula:
$$R I R = \frac{{W}_{1}}{{T}_{1}} + … + \frac{{W}_{N}}{{T}_{N}}$$
wherein RIR is the resilience impact rating, W₁ . . . W_{N} are weights, and T₁ . . . T_{N} are the set of time values for N levels of increasing impact.

25. The business impact analysis system of claim 21, further comprising means for developing a response plan based on the resilience impact rating of the time-critical business unit.
